(19) United States
(12) Patent Application Publication
(10) Pub. No.: US 2009/0232722 A1
(43) Pub. Date: Sep. 17, 2009

(54) METHOD FOR PRODUCING SILICON

(76) Inventor: Kunio Saegusa, Tsukubamirai-shi (JP)

Correspondence Address: BIRCH STEWART KOLASCH & BIRCH, PO BOX 747, FALLS CHURCH, VA, 22040-0747, US

(21) Appl. No.: 12/063,574

(22) PCT Filed: Aug. 18, 2006
(86) PCT No.: PCT/JP2006/316667

§ 371 Date: Feb. 11, 2008

(30) Foreign Application Priority Data
Aug. 19, 2005 (JP) 2005-238314

(51) Int. Cl. C01B 33/021

(52) U.S. Cl. 423/350

(57) ABSTRACT

A method for producing silicon is provided. The silicon production method comprises the step (i) of reducing a halosilane represented by the formula (1) with a metal

SiHₙX₄₋ₙ (1)

wherein n is an integer of 0 to 3, X is at least one selected from F, Cl, Br and I, with the proviso that plural Xs may be the same or different from each other, wherein said metal has a melting point of not higher than 1300° C. and takes a liquid phase of spherical or thin film shape in the reduction of the halosilane, with the proviso that when the liquid phase is in the shape of sphere, the relationships (A), (B) and (C) are satisfied wherein r is radius (μm) of the sphere, t is reduction time (min) and x is reduction temperature (° C.), while when the liquid phase is in the shape of thin film, the relationships (A′), (B′) and (C) are satisfied wherein r′ is thickness (μm) of the thin film, t is reduction time (min) and x is reduction temperature (° C.):

ln (r/√t)≦(10.5−7000/(x+273)) (A)

ln (r′/√t)≦(10.5−7000/(x+273)) (A′)

1≦r≦250 (B)

1≦r′≦500 (B′)

400≦x≦1300 (C)

### TECHNICAL FIELD

The present invention relates to a method for producing silicon. Particularly, the present invention relates to a method for producing silicon to serve as a suitable material for production of solar cells.

### BACKGROUND ART

As a silicon used for solar cells, an off-grade product of a semiconductor grade silicon is used as a main material. The semiconductor grade silicon is produced by purifying a metallurgical grade silicon. The metallurgical grade silicon is produced by mixing carbon and silica and reducing the mixture in an arc furnace. The metallurgical grade silicon is reacted with HCl to obtain trichiorosilane, and trichlorosilane is purified by distillation, then, reduced at high temperature using hydrogen, thereby producing the semiconductor grade silicon. This method is capable of producing ultra high purity silicon, however, shows high cost because of facts that the conversion to silicon is low, and a large amount of hydrogen is necessary for rendering this equilibrium advantageous for silicon; that its conversion rate is low even after the above-described procedure, and a large amount of unreacted gas should be recycled and used again; that various halogenated silanes are generated after the reaction, and these should be separated by distillation again; that a large amount of silicon tetrachloride which cannot be reduced with hydrogen finally is generated, and the like.

On the other hand, solar cells are paid being attention as an effective solution against recent environmental problems due to a carbon dioxide gas and the like, and demand for the solar cells is increasing remarkably.

However, conventional solar cells are sill expensive, and the price of electric power generated by the solar cells is higher by several times as compared with commercial electricity. Demand for solar cells is increasing in response to environmental problems and increasing energy demand, as a result, a lack of the material cannot be compensated only by conventional semiconductor off-grade silicon, causing a demand for supply of a large amount of low cost solar cells.

Conventionally, there are various proposals on a method for producing silicon for solar cells. For example, there are reported a method including the steps of preparing a high purity carbon and a high purity silica, and reducing the high purity silica with the high purity carbon in a furnace made of high purity refractory to obtain a high purity silicon (JP-A Nos. 55-136116, 57-209814, and 61-117110); a method of reducing silicon tetrachloride with zinc; a method of reducing trichlorosilane in a fluidized bed reactor; and a method of reducing silicon tetrachloride with aluminum (Shiro Yoshizawa, Asao Mizuno, Arata Sakaguchi, Reduction of Silicon Tetrachloride with Aluminum, Kogyo Kagaku Zasshi vol. 64(8), pp. 1347-50 (1961), JP-A Nos. 59-182221, 63-103811, and 2-64006).

However, none of them is practically used as a method for producing a silicon for solar cells.

### DISCLOSURE OF THE INVENTION

The present invention has an object of providing a method for producing silicon efficiently, and particularly, a method for efficiently producing a silicon to serve as a suitable material for production of solar cells.

The present inventor has intensively studied a method for producing silicon, resultantly leading to completion of the present invention.

That is, the present invention provides 1) a method for producing silicon comprising the step (i) of reducing a halosilane represented by the formula (1) with a metal,

SiHₙX₄₋ₙ (1)

wherein n is an integer of 0 to 3, X is at least one selected from F, Cl, Br and I, with the proviso that plural Xs may be the same or different from each other, and the metal has a melting point of not higher than 1300° C. and takes a liquid phase of spherical or thin film shape in the reduction of the halosilane, with the proviso that when the liquid phase is in the shape of sphere, the relationships (A), (B) and (C) are satisfied wherein r is radius (μm) of the sphere, t is reduction time (min) and x is reduction temperature (° C.), while when the liquid phase is in the shape of thin film, the relationships (A′), (B′) and (C) are satisfied wherein r′ is thickness (μm) of the thin film, t is reduction time (min) and x is reduction temperature (° C.):

ln (r/√t)≦(10.5−7000/(x+273)) (A)

ln (r′/√t)≦(10.5−7000/(x+273)) (A′)

1≦r≦250 (B)

1≦r′≦500 (B′)

400≦x≦1300 (C).

The present invention provides 2) the method according to 1), further comprising the step (ii) of separating the silicon obtained in the step (i) from the metal halide.

Furthermore, the present invention provides 3) the method according to 1) or 2), further comprising the step (iii) of purifying the silicon obtained in the prior step.

### BRIEF DESCRIPTION OF DRAWINGS

FIG. 1 shows silicon (Si) mapping, aluminum (Al) mapping and scanning electron microscope (SEM) image, of a silicon particle having a particle diameter of 150 μm obtained in Example 1.

FIG. 2 shows Si mapping, Al mapping and SEM image, of a particle having a particle diameter of 1 mm obtained in Comparative Example 1.

### MODES FOR CARRYING OUT THE INVENTION

The method for producing silicon of the invention includes the step (i) of reducing a halosilane with a metal.

### Halosilane

The halosilane is represented by the above-described formula (1), and examples thereof include silicon tetrachloride, trichlorosilane, dichlorosilane and monochlorosilane. As the halosilane, high purity products prepared by conventional methods may be advantageously used. Preparation of the halosilane may be advantageously carried out, for example, by a method of halogenating silica at a high temperature of 1000 to 1400° C. in the presence of carbon, or a method of reacting a metallurgic grade silicon with a halogen or hydrogen halide. By distilling thus obtained halosilane, a halosilane having a high purity of not less than 6 N may be prepared.

It is preferable that the amount of the halosilane is excess than the amount of metals described later. Since a reaction of a halosilane with a metal has large negative reaction free energy, the reaction proceeds until the stoichiometric ratio on equilibrium theory is attained. It is advantageous that the amount of the halosilane is excess than the amount of metals from the standpoint of kinetics and later separation step.

In the step (i), a halosilane is usually supplied in the form of gas. A halosilane may be supplied singly, alternatively, a halosilane may be diluted with an inert gas to give a mixture gas of a halosilane and an inert gas which is then supplied, for controlling reactivity. The mixture gas has a halosilane content of preferably not less than 5 vol %. Examples of the inert gas include argon.

### Metal

The metal is used as a reductant for halosilane. The metal has an ability of reducing a halosilane at temperatures described later, and is a reducing metal. The metal has a melting point of usually not higher than 1300° C., preferably not higher than 1000° c., more preferably not higher than 900° C.

Examples of the metal include sodium (Na), potassium (K), magnesium (Mg), calcium (Ca), aluminum (Al) and zinc (Zn), preferably Al. These may be used singly in combination.

The metal has preferably a high purity from the standpoint of improving the purity of the resulting silicon. For example, the purity is preferably not less than 99.9%, more preferably 99.99%. The metal should have preferably a very low content of boron (B), phosphorus (P), carbon (C), iron (Fe), copper (Cu), gallium (Ga), titanium (Ti) and nickel (Ni), among impurities in the metal.

P in the metal is difficult to be removed sufficiently in a directional solidification step described later, thus, the P content is preferably not more than 1 ppm, more preferably not more than 0.5 ppm, further preferably not more than 0.3 ppm. Also B is difficult to be removed sufficiently in a directional solidification step, thus, the B content is preferably not more than 5 ppm, more preferably not more than 1 ppm, further preferably not more than 0.3 ppm. Further, the C content is preferably not more than 20 ppm, more preferably not more than 10 ppm. Regarding Fe, Cu, Ga, Ti and Ni, the content of any impurity is preferably not more than 30 ppm, more preferably not more than 10 ppm, further preferably not more than 3 ppm, from the standpoint of improving a yield in a directional solidification step.

Such high purity metals may be purified by a conventional method. For example, high purity aluminum is obtained by purifying electrolytically reduced aluminum (primary aluminum) by segregation solidification, three layer electrolysis and the like.

The metal supplied to the step (i) may satisfy conditions described later in a reduction. The metal is, for example, in the shape of sphere or thin film. The metal may have other shape depending on the apparatus and the like. The metal has preferably a spherical shape with large specific surface area from the standpoint of reaction rate.

When the metal is in the shape of sphere, its radius r is usually not more than 250 μm, preferably not more than 150 μm, more preferably not more than 100 μm, further preferably not more than 50 μm and preferably not less than 1 μm, more preferably not less than 2.5 μm, further preferably not less than 5 μm.

When the metal is in the shape of thin film, its thickness r′ is usually not more than 500 μm, preferably not more than 300 μm, more preferably not more than 200 μm, further preferably not more than 100 μm and preferably not less than 1 μm, more preferably not less than 10 μm.

Preparation of a metal in the shape of particle may be advantageously carried out, for example, by gas atomization in which a molten metal is supplied into a gas jet stream, a rotating disk method of spraying a molten metal onto a disk rotating at high speed, a method of ejecting a molten metal from a nozzle of disk rotating at high speed with centrifugal force, or a method of ejecting a molten metal from nozzles at high speed.

In the gas atomization, the radius of a particle may be advantageously adjusted, for example, by changing the kind, quantity and flow rate of a gas for atomization, and the feed rate of a metal. For example, higher the gas flow rate or larger the gas quantity, the resulting silicon has smaller particle radius. Further, smaller the feed rate of a metal, the resulting silicon has smaller particle radius.

In the rotating disk method, higher the rotating speed, larger the disk diameter, or smaller the metal feed rate, the resulting silicon has smaller particle radius.

In the method of ejecting from nozzles, the radius of a particle may be advantageously adjusted, for example, by changing an inner diameter of the nozzle.

Preparation of a metal with the shape of thin film may be advantageously carried out, for example, by a method in which a partition wall is fixed in a heat-resistant vessel, and a molten metal thin film is formed on the partition wall; a method in which a rack is fixed in a vessel, and a molten metal thin film is formed on the rack; a method in which a powder packed bed made of inert material particles is fixed in a vessel, and a molten metal is dropped on the packed bed; or a method of ejecting a molten metal with the shape of thin film from a slit.

### Reduction

The reduction in the step (i) may be carried out under the condition satisfying given relations of the radius of a molten metal (hereinafter to as “liquid phase”), time and temperature. When the liquid phase is in the shape of sphere, the reduction is carried out under the condition satisfying the above-described formulae (A), (B) and (C) wherein r is radius (μm), t is reduction time (min) and x is reduction temperature (° C.). When the liquid phase is in the shape of thin film, the reduction is carried out under the condition satisfying the above-described formulae (A′), (B′) and (C) wherein r′ is thickness (μm), t is reduction time (min) and x is reduction temperature (° C.).

From the viewpoint of productivity of the step (i), it is preferable to adjust x and r or r′ so that the reduction time t is in the range of not less than 0.1 minute and not more than 4320 minutes.

Usually, larger the specific surface area of a molten metal particle or film, namely, smaller the particle radius or film thickness, the reduction proceeds faster. Too short reduction time is not preferable since then an unreacted metal remains to constitute an impurity in silicon. Too long reduction time does not give a possibility of further improvement in yield, causes consumption of fruitless times, leading to a cost up factor.

Since dependency of diffusion distance of an atom on time is in proportion to square root of time, r or r′ is estimated to be in proportion to square root of t, and the formula (A) or the formula (A′) is induced based on the results of examples described later, in the invention.

The reduction temperature x is not lower than 400° C. and not higher than 1300° C., preferably not lower than 500° C. and not higher than 1200° C., more preferably not lower than 600° C. and not higher than 1000° C. from the viewpoint of vessel material and energy cost. When the reduction temperature x is lower than 400° C., the reduction rate is not sufficient. On the other hand, when the reduction temperature x is higher than 1300° C., a halosilane is reacted with a silicon product to generate a silicon subhalide, leading to decrease in the yield of silicon. The dependency of the reduction on temperature is estimated to indicate temperature dependency according to activation energy of the reduction, represented by the formula exp(−E/kT) in the chemical kinetics.

When the molten metal (liquid phase) is in the shape of sphere, its radius r (μm) is usually 1 to 250 μm, preferably 1 to 150 μm, more preferably 2.5 to 100 μm, further preferably 5 to 50 μm. When the radius r is less than 1 μm, it is difficult to handle a product. When over 250 μm, the reduction temperature x becomes higher or the redunction time t becomes longer for satisfying the formula (A), leading to disadvantages for industrial production from the standpoint of reduction vessel material, production time and the like.

When the molten metal is in the shape of thin film, the thickness r′ (μm) is usually 1 to 500 μm, preferably 1 to 300 μm, more preferably 5 to 200 μm, further preferably 10 to 100 μm.

When silicon obtained by reducing a silicon halide (for example, SiCl₄) maintains the shape of a metal before reduction step, a radius of a molten metal drop may be calculated from a radius of the resultant silicon particle.

Though a metal causes a change in volume according to valence and density, a silicon particle having the equivalent radius is obtained. For example, when the metal is aluminum (Al), the amount of silicon (Si) to be reduced is ¾ mol based on Al since Al has a valence of 3. Since the atomic weight is 27 for Al and 28 for Si, if 1 mol of Al is reacted, 21 g of Si is obtained. Since the density is 2.7 for Al and 2.33 for Si, 10 cm³ of Al changes into 9 cm³ of Si. This means a particle radius ratio of about 96%, indicating that particle radii thereof are substantially identical.

The reduction is carried out under an atmosphere containing a halosilane gas. The atmosphere has a halosilane content of preferably not less than 5 vol %, and it is more preferable that the atmosphere is free from water and gas such as oxygen from the standpoint of promoting the reduction. The atmosphere may contain a hydrogen halide from the standpoint of purifying silicon. On the other hand, since a metal consumption rate deteriorates according to the amount of a hydrogen halide (for example, hydrogen chloride), the content of a hydrogen halide is preferably adjusted in case a reduction is carried out under an atmosphere containing a hydrogen halide.

The reduction is usually carried out in a vessel made of a material having heat-resistance at the reduction temperature and not contaminating silicon as a product. The material of the vessel includes, for example, carbon, silicon carbide, silicon nitride, aluminum nitride, alumina and quartz.

In the step (i), a thin film or drop of a molten metal may be usually reacted with a halosilane to obtain silicon and metal halide (for example, aluminum chloride) as products.

### Separation

The method of the invention may further include the step (ii) of separating the silicon obtained in the step (i) from the metal halide.

The separation step (ii) may advantageously be a method of separating silicon from a metal halide, and depending on the form of the metal halide, for example, solid-gas separation, solid-liquid separation, leaching, water-washing and the like may be carried out.

When the metal is aluminum, aluminum chloride is by-produced. Since aluminum chloride takes a gas phase at temperatures not lower than 200° C., the mixture obtained in the step (i) is kept at temperatures not lower than 200° C. and a mixture of the unreacted halosilane, dilution gas and aluminum chloride gas, and silicon of the product, are solid-liquid separated. Then, the mixture is cooled to not higher than 200° C., solidified, separated to recover aluminum chloride from the unreacted halosilane and dilution gas. The unreacted halosilane is if necessary, separated from the dilute gas. The separated halosilane may be used to react with aluminum. In separation from the dilution gas, a mixture of the unreacted halosilane and dilution gas is cooled, condensed, and gas-liquid separated to recover a halosilane

The metal halide (for example, aluminum chloride) by-produced in the step (i) may be recycled since The metal halide has high purity. For example, the metal halide may be electrolyzed to obtain metal and halogen, and the halogen is used to produce halosilane and the metal is used to reduce halosilane. When the metal is aluminum, the obtained anhydrous aluminum chloride may be used as a catalyst, alternatively may be reacted with water to produce polyaluminum chloride, or may be neutralized with alkali to produce aluminum hydroxide, or may be reacted with water vapor or oxygen at high temperature to produce alumina.

The silicon obtained in the step (i) usually has a B content of not more than 1 ppm, a P content of not more than 1 ppm, and a content of any element of Fe, Cu, Ga, Ti and Ni of not more than 10 ppm.

### Purification

The method of the invention may further include the step (iii) of purifying the silicon obtained in the step (i) or optional step (ii). The method, for example, may include the step (iii-1) of directionally solidifying silicon, the step (iii-2) of melting silicon under high vacuum (vacuum melting), preferably, the step (iii-1). These may be used singly or in combination. By these steps, impurities contained in silicon are further reduced.

In the step (iii-1), one end having a high impurity content of a solid obtained by directional solidification step is removed, to obtain a high purity silicon. The high purity silicon usually has a boron content of not more than 0.1 ppm, a phosphorus content of not more than 0.5 ppm, and a content of any element of Fe, Cu, Ga, Ti and Ni of not more than 1.0 ppm. Directionally solidification may be advantageously carried out, for example, under condition such as growth rate of about 0.01 to about 0.1 mm/min.

Thus obtained silicon is used suitably for production of solar cells.

Embodiments of the present invention are illustrated in the above description. The embodiments are only exemplary, and the scope of the invention is not limited to these embodiments. The scope of the present invention is recited in Claims, and includes all variations within meanings and ranges equivalent to the Descriptions of Claims.

### EXAMPLES

The present invention will be illustrated by examples below, but the present invention is not limited to them. Measurements in the present specification were carried out under the following conditions.

Purity: A sample was ground, then, dissolved in hydrochloric acid for 48 hours, then, analyzed with JCP-AES.
TS Cross-section image: A sample was embedded in a resin, then, cut, and the cross-section is observed with SEM.
Element analysis: A small portion of the same cross-section as SEM observation is analyzed with EPMA (Electron Probe Microanalysis).

### Example 1

Three layer electrolytic high purity aluminum (manufactured by Sumitomo Chemical Co., Ltd., composition: see Table 1) was gas-atomized in helium to obtain a spherical particle. The spherical particle was sieved to obtain aluminum particle having a diameter of 75 to 150 μm (radius: 37.5 to 75 μm). 0.5 g of the aluminum particle were placed in a quartz tube of an electric furnace, and an atmosphere in the tube was substituted by an Ar gas.

The electric furnace was heated up to 600° C. at a rate of 10° C./min. Ar gas was passed through a vessel filled with silicon tetrachloride (manufactured by Wako Pure Chemical Industries Ltd.) at a flow rate of 0.5 L/min, and was introduced into the tube. The temperature of the tube was kept for 180 minutes. Thereafter, Ar gas was introduced, and the temperature was cooled to room temperature. The melting point of Al is not lower than 600° C., however, if Si is present in Al, the eutectic point of Al—Si is 577° C., thus, a liquid phase was present in the reduction. Since Al and Si have densities and molecular weights which are close to each other, a solid Al particle maintained substantially the same radius even after it was converted to an Al—Si molten particle. According to particle SEM images before and after reduction, it is confirmed that the Al particle converted to Si particle with almost the same radius as the Al particle.

The Si particle after reduction had a diameter of (=diameter of Al particle) of 150 μm (radius r: 75 μm).

Thus, ln(r/√t)=1.721, and
10.5−7000/(x+273)=2.482, satisfying the formula (A).

After completion of the reduction, the resultant silicon particle was taken out, washed with pure water, then, dried and the purity thereof was determined. The cross-section of each particle was observed with SEM and EPMA, and the yield thereof was calculated from Al/Si area ratio. The yield was not less than 99%.

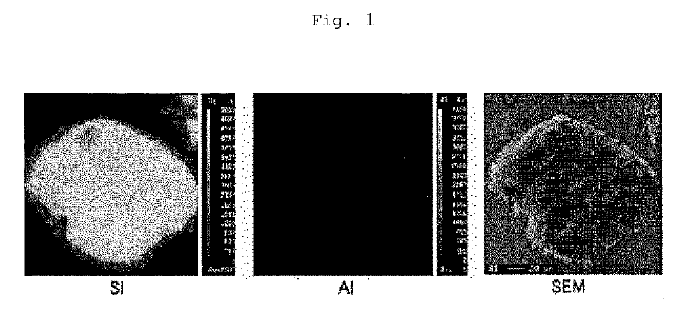

The purity was shown in Table 1, and the cross-section images were shown in FIG. 1.

As shown in FIG. 1, the Al particle kept its outline to constitute a Si particle. As shown in Table 1, a high purity silicon having a P content of less than 0.5 ppm was obtained.

TABLE 1
Element anlysis of aluminum and resultant silicon

| | | Resultant |
|---|---|---|
| | Aluminum | silicon |
| Impurity | (unit: ppm) | (unit: ppm) |
| B | 0.05 | 0.03 |
| Na | 0.02 | 0.1 |
| Mg | 0.45 | <0.05 |
| P | 0.27 | 0.25 |
| S | 0.13 | 0.27 |
| Fe | 0.73 | 0.52 |
| Co | <0.005 | <0.01 |
| Ni | 0.02 | 0.02 |
| Ti | 0.03 | 0.11 |
| Cu | 1.9 | <0.05 |
| Zn | <0.05 | <0.05 |
| Ga | 0.57 | <0.05 |

### Example 2

The same operation as in Example 1 was carried out excepting that high purity aluminum was sieved into particles of 37 to 63 μm, to obtain Si particle. The Si particle after reduction had a diameter (=diameter of Al particle) of 150 μm.

ln(r/√t)=0.622, and
10.5−7000/(x+273)=2.482, satisfying the formula (A).

After completion of the reduction, the resultant silicon was taken out, ground and washed with dilute hydrochloric acid, then, with pure water, then, dried and the purity thereof was determined. The cross-section of each particle was observed with SEM and EPMA, and the yield thereof was calculated from Al/Si area ratio. The yield was not less than 99%.

### Example 3

The same operation as in Example 1 was carried out excepting that the reduction conditions were changed from 600° C. for 180 minutes to 750° C. for 5 minutes, to obtain Si particle.

The solid Al particle maintained substantially the same radius even after it was converted to an Al molten particle.

According to particle SEM images before and after reduction, it is confirmed that the Al particle converted to Si particle with the same radius as the Al particle. The Si particle after reduction had a diameter (=diameter of Al particle) of 100 μm.

ln(r/√t)=3.107, and
10.5−7000/(x+273)=3.657, satisfying the formula (A).

After completion of the reduction, the resultant silicon was taken out, ground and washed with dilute hydrochloric acid, then, with pure water, then, dried and the purity thereof was determined. The cross-section of each particle was observed with SEM and EPMA, and the yield thereof was calculated from Al/Si area ratio. The yield was not less than 99%.

### Example 4

The same operation as in Example 1 was carried out excepting that the reduction conditions were changed from 600° C. for 180 minutes to 680° C. for 180 minutes, to obtain Si particle. The Si particle after reduction had a diameter of 150 μm.

ln(r/√t)=1.721, and
10.5−7000/(x+273)=3.155, satisfying the formula (A).

After completion of the reduction, the resultant silicon was taken out, and the cross-section was observed with SEM and EPMA, and the yield thereof was calculated from Al/Si area ratio. The yield was 100%.

### Comparative Example 1

The same operation as in Example 4 was carried out except that high purity aluminum particle having a diameter of not smaller than 500 μm separated using sieve was used. The particle after reduction had a diameter of 1 mm.

ln(r/√t)=3.618, and
10.5−7000/(x+273)=3.154, not satisfying the formula (A).

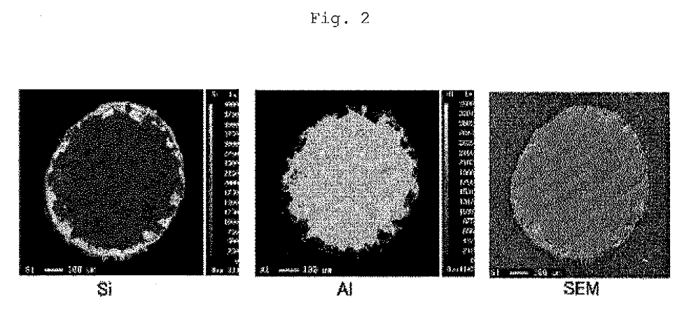

After completion of the reduction, the resultant silicon was taken out, and washed with dilute hydrochloric acid, then, with pure water, then, dried and the purity thereof was determined. The cross-section thereof was observed with SEM. The cross-section images were shown in FIG. 2. As shown in FIG. 2, the peripheral parts of the particle were made of Si, and the inner part thereof was made of an Al—Si alloy, and the reduction into Si did not proceed sufficiently.

### Comparative Example 2

The same operation as in Example 1 was carried out except that spherical high purity aluminum particle having a diameter of from 150 to 500 μm separated using sieve was used and the reduction conditions were changed to 700° C. for 5 minutes. The Si particle after reduction had a radius of 300 μm.

ln(r/√t)=4.206, and
10.5−7000/(x+273)=3.306, not satisfying the formula (A).

After completion of the reduction, the resultant Si spherical particle was taken out, and washed with dilute hydrochloric acid, then, with pure water, then, dried and the purity thereof was determined. The cross-section thereof was observed with SEM and EPNMA, and the yield thereof was calculated from Al/Si area ratio, as a result, the peripheral parts of the particle were made of Si, and the inner part thereof (region at the center of the particle, and having a diameter of about 100 μm) was made of an Al—Si alloy (Si 13%), and the reduction into Si did not proceed sufficiently.

### Example 5

The same operation as in Example 1 was carried out except that the reduction conditions were changed to 700° C. for 5 minutes, to obtain Si particle. The Si particle after reduction had a diameter (=diameter of Al particle) of 120 μm.

ln(r/√t)=3.29, and
10.5−7000/(x+273)=3.3058, satisfying the formula (A).

The yield was 98%.

### Example 6

The same operation as in Example 1 was carried out except that the reduction conditions were changed to 800° C. for 5 minutes, to obtain Si particle. The Si particle after reduction had a diameter of from 125 to 180 μm.

For the particle having a diameter of 125 μm,

ln(r/ft)=3.330, and
10.5−7000/(x+273)=3.9763, satisfying the formula (A), and the yield thereof was 100%.

For the particle having a diameter of 180 μm,

ln(r/Ft)=3.695, and
10.5−7000/(x+273)=3.9763, satisfying the formula (A), and the yield thereof was 99%.

### Example 7

The same operation as in Example 1 was carried out except that high purity aluminum particle having a diameter of 75 to 500 μm separated using sieve was used and the reduction conditions were changed to 900° C. for 5 minutes, to obtain Si particle. The Si particle after reduction had a diameter of 130 to 300 μm.

For the particle having a diameter of 130 μm,

ln(r/√t)=3.370, and
10.5−7000/(x+273)=4.5324, satisfying the formula (A), and the yield thereof was 100%.

For the particle having a diameter of 300 μm,

ln(r/√t) 4.206, and
10.5−7000/(x+273)=4.5324, satisfying the formula (A), and the yield thereof was 96%.

### Example 8

The same operation as in Example 1 was carried out except that the reduction conditions were changed to 800° C. for 10 minutes, to obtain Si particle. The Si particle after reduction had a radius of 105 to 150 μm.

For the particle having a diameter of 105 μm,

ln(r/√t)=2.810, and
10.5−7000/(x+273)=3.9763, satisfying the formula (A), and the yield thereof was 100%.

For the particle having a diameter of 150 μm,

ln(r/√t)=3.166, and
10.5−7000/(x+273)=3.9763, satisfying the formula (A), and the yield thereof was 99%.

### Example 9

The same operation as in Example 1 was carried out except that the reduction conditions were changed to 800° C. for 1 minute, to obtain Si particle. The Si particle after reduction had a diameter of 84 μm.

ln(r/Ft)=3.736, and
10.5=7000/(x+273)=3.9763, satisfying the formula (A), and the yield thereof was 99%.

### Comparative Example 3

The same operation as in Example 1 was carried out except that high purity aluminum particle having a diameter of 150 to 500 μm separated using sieve was used and the reduction conditions were changed to 700° C. for 5 minutes. The Si particle after reduction had a diameter of 220 to 330 μm.

For the particle having a diameter of 220 μm,

ln(r/√t)=3.896, and
10.5−7000/(x+273)=3.3058, not satisfying the formula (A), and the yield thereof was 80%.

For the particle having a diameter of 330 μm,

ln(r/Ft)=4.206, and
10.5−7000/(x+273)=3.3058, not satisfying the formula (A). The resultant particle kept its outline and the peripheral parts thereof were made of Si, however, the inner part thereof was made of Al—Si having a eutectoid formulation, containing unreacted Al residue.

### Comparative Example 4

The same operation as in Example 1 was carried out except that high purity aluminum particle having a diameter of 150 to 500 μm separated using sieve was used and the reduction conditions were changed to 550° C. for 30 minutes. The Si particle after reduction had a diameter of 200 μm.

ln(r/√t)=2.905, and
10.5−7000/(x+273)=1.995, not satisfying the formula (A). The resultant particle kept its outline and the peripheral parts thereof were made of Si, however, the inner part thereof was made of Al—Si having a eutectoid formulation, containing unreacted Al residue.

### Comparative Example 5

The same operation as in Example 1 was carried out except that high purity aluminum particle having a diameter of not smaller than 500 μm separated using sieve was used and the reduction conditions were changed to 800° C. for 1 minute. The Si particle after reduction had a diameter of 750 μm.

ln(r/√t)=5.927, and
10.5−7000/(x+273)=3.980, not satisfying the formula (A). The resultant particle kept its outline and the peripheral parts thereof were made of Si, however, the inner part thereof was made of an Al—Si particle having a eutectoid formulation, containing unreacted Al residue.

### INDUSTRIAL APPLICABILITY

According to the production method of the present invention, high purity silicon is obtained efficiently (for example, the yield thereof is not less than 90%).

1. A method for producing silicon comprising the step (i) of reducing a halosilane represented by the formula (I) with a metal
SiHₙX₄₋ₙ (1)
wherein n is an integer of 0 to 3, X is at least one selected from F, Cl, Br and I, with the proviso that plural Xs may be the same or different from each other,
the metal has a melting point of not higher than 1300° C. and takes a liquid phase of spherical or thin film shape in the reduction of the halosilane, with the proviso that when the liquid phase is of spherical shape, the relationships (A), (B) and (C) are satisfied wherein r is radius (μm) of the sphere, t is reduction time (min) and x is reduction temperature (° C.), while when the liquid phase is in the shape of thin film, the relationships (A′), (B′) and (C) are satisfied wherein r′ is thickness (μm) of the thin film, t is reduction time (min) and x is reduction temperature (° C.):
ln (r/√t)≦(10.5−7000/(x+273)) (A)
ln (r′/√t)≦(10.5−7000/(x+273)) (A′)
1≦r≦250 (B)
1≦r′≦500 (B′)
400≦x≦1300 (C)

2. The method according to claim 1, further comprising the step (ii) of separating the silicon obtained in the step (i) from the metal halide.

3. The method according to claim 1 or 2, further comprising the step (iii) of purifying the silicon obtained in the prior step.

4. The method according to claim 3, wherein purification is carried out by directional solidification or vacuum melting.

5. The method according to claim 4, wherein purification is carried out by directional solidification.

6. The method according to claim 1, wherein the halosilane is supplied in the form of a mixture gas containing inert gas.

7. The method according to claim 6, wherein the mixture gas has a halosilane content of not less than 5 vol %.

8. The method according to claim 1, wherein the halosilane is supplied in the form of a halosilane gas.

9. The method according to claim 1, wherein the metal is at least one selected from the group consisting of Na, K, Mg, Ca, Al and Zn.

10. The method according to claim 9, wherein the metal is Al.

11. The method according to claim 1, wherein the metal has a purity of not less than 99.9%, and the purity of the metal is the balance obtained by deducting the total content of itself, Fe, Cu, Ga, Ti and Ni from 100%.

12. The method according to claim 1, wherein the metal has a boron content of not more than 5 ppm, a phosphorus content of not more than 1 ppm and a Fe content of not more than 30 ppm.

13. The method according to claim 1, wherein the metal is in the shape of thin film having a thickness of not more than 200 μm.

14. The method according to claim 1, wherein the metal is in the shape of sphere having a radius of not more than 100 μm.

15. The method according to claim 3, wherein the silicon obtained in the prior step has a boron content of not more than 1 ppm, a phosphorus content of not more than 1 ppm, and a content of each element of Fe, Cu, Ga, Ti or Ni of not more than 10 ppm.

16. A method for producing silicon comprising the step (i′) of reducing a halosilane represented by the formula (I) with a metal
SiHₙX₄₋ₙ (1)
wherein n is an integer of 0 to 3, X is at least one selected from F, Cl, Br and I, with the proviso that plural Xs may be the same or different from each other,
the metal has a melting point of not higher than 1300° C. and has a spherical or thin film shape in supplying, with the proviso that when the metal is in the shape of sphere, the relationships (A), (B) and (C) are satisfied wherein r is radius (μm) of the sphere, t is reduction time (min) and x is reduction temperature (° C.), while when the metal is in the shape of thin film, the relationships (A′), (B′) and (C) are satisfied wherein r′ is thickness (μm) of the thin film, t is reduction time (min) and x is reduction temperature (° C.):
ln (r/√t)≦(10.5−7000/(x+273)) (A)
ln (r′/√t)≦(10.5−7000/(x+273)) (A′)
1≦r≦250 (B)
1≦r′≦500 (B′)
400≦x≦1300 (C)

17. The method according to claim 16, further comprising the step (ii) of separating the silicon obtained in the step (i) from the metal halide.

18. The method according to claim 16 or 17, further comprising the step (iii) of purifying the silicon obtained in the prior step.

19. The method according to claim 18, wherein purification is carried out by directional solidification or vacuum melting.

20. The method according to claim 19, wherein purification is carried out by directional solidification.
